(19) United States
(12) Patent Application Publication
(10) Pub. No.: US 2007/0147823 A1
(43) Pub. Date: Jun. 28, 2007

(54) Method for controlling the picture capturing process of a digital camera

(75) Inventors: Chang-Wei Cheng, Taipei (TW); Shih-Chang Yeng, Taipei (TW)

Correspondence Address: BACON & THOMAS, PLLC, 625 SLATERS LANE, FOURTH FLOOR, ALEXANDRIA, VA, 22314, US

(73) Assignee: PREMIER IMAGE TECHNOLOGY CORPORATION, Taipei (TW)

(21) Appl. No.: 11/484,642

(22) Filed: Jul. 12, 2006

(30) Foreign Application Priority Data
Dec. 23, 2005 (TW) 094146061

(51) Int. Cl. G03B 15/03

(52) U.S. Cl. 396/165

(57) ABSTRACT

The present invention provides a method for controlling the picture capturing process of a digital camera, which includes the steps of: determining whether the digital camera is operating in an auto flash mode; when the digital camera is operating in the auto flash mode, then further determining whether a flash of the digital camera is charging; if the flash of the digital camera is charging, then further detecting whether the ambient light value is higher than a predetermined value; and if the ambient light value is higher than the predetermined value, then causing the digital camera to enter into a ready status that is capable of capturing pictures immediately.

### BACKGROUND OF THE INVENTION

1. Field of the Invention

The present invention relates to a method for controlling the picture capturing process of a digital camera, and, more particularly, to a method for controlling the picture capturing process of a digital camera operating in an auto flash mode.

2. Description of the Related Art

Generally, in order to provide a high quality picture, a digital camera requires a high quality flash. The flash built into the digital camera is an essential element of the camera. The flash is a key element for high quality pictures.

For operational convenience, the prior art digital camera usually provides several flash operating modes among which a user may choose, such as a forced-flash mode, a no-flash mode, a red-eye reduction mode, or an auto flash mode. However, when the digital camera operates in the auto flash mode, after the first shot, the user needs to wait for the flash to be fully charged before taking another picture.

Since it may take a few seconds for the flash to complete charging, the user is forced to waste time waiting, and may even miss the next desired shot. Furthermore, unnecessary flash charging processes in the prior art digital camera consume battery power, which reduces the operating time of the digital camera.

Therefore, it is desirable to provide a method for controlling the picture capturing process of a digital camera operating in an auto flash mode to mitigate and/or obviate the aforementioned problems.

### SUMMARY OF THE INVENTION

The present invention provides a method for controlling the picture capturing process of a digital camera operating in an auto flash mode

The present invention provides a method for controlling the picture capturing process of a digital camera, which comprises: determining whether the digital camera is operating in an auto flash mode; when the digital camera is operating in the auto flash mode, then further determining whether a flash of the digital camera is charging; if the flash of the digital camera is charging, then further detecting whether the ambient light value is higher than a predetermined value; and if the ambient light value is higher than the predetermined value, then causing the digital camera to enter into a ready status that is capable of capturing pictures immediately.

In one embodiment of the present invention, the predetermined value is a predetermined light value about 8.5.

Furthermore, in one embodiment of the present invention, the method can detect whether the flash of the digital camera is charging, if the flash of the digital camera is charging, then further detect whether an ambient light value is higher than a predetermined value; otherwise, if the flash of the digital camera is not charging, cause the digital camera to enter into a ready status that is capable of capturing pictures immediately

The present invention also provides a digital camera capable of controlling an operation by detecting an ambient light, the digital camera comprises: a flash for providing illumination during a picture capturing process; a flash state determination unit for determining whether the flash is operating in the auto flash mode to operate the digital camera; and an ambient light detection unit for detecting whether the ambient light is higher than a predetermined value when the digital camera is operating in the auto flash mode; wherein when the ambient light is higher than the predetermined value, the ambient light detection unit places the digital camera into a ready status that is capable of capturing pictures immediately, and when the ambient light is not higher than the predetermined value, the digital camera is inoperable until the flash has charged.

In one embodiment of the present invention, the digital camera further comprises a flash charging state determination unit for determining whether the flash is charging when the digital camera is operating in the auto flash mode; wherein if the flash is still charging, the flash charging state determination unit causes the ambient light detection unit to detect the ambient light

Other objects, advantages, and novel features of the invention will become more apparent from the following detailed description when taken in conjunction with the accompanying drawings.

### BRIEF DESCRIPTION OF THE DRAWINGS

FIG. 1 is a flowchart of a first embodiment according to the present invention.

FIG. 2 is a flowchart of a second embodiment according to the present invention.

FIG. 3 is a schematic drawing of a digital camera according to the present invention.

### DETAILED DESCRIPTION OF THE PREFERRED EMBODIMENT

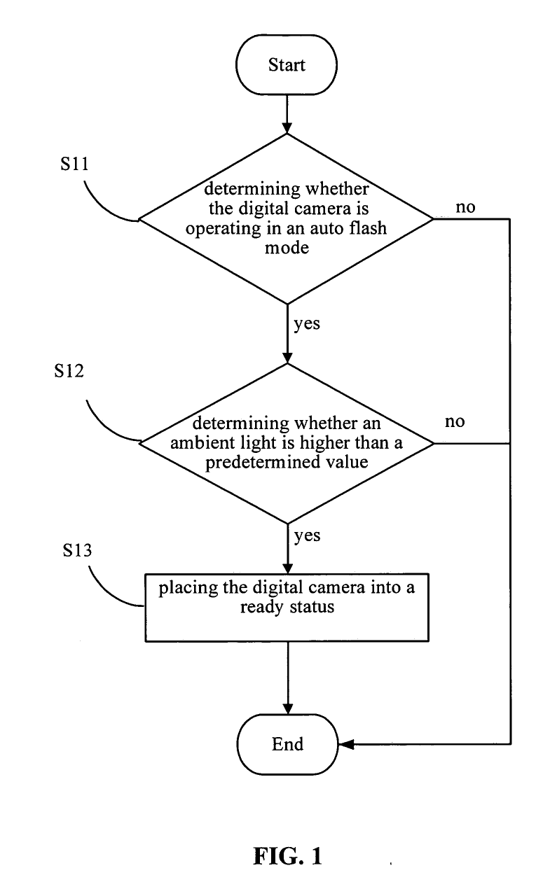

Please refer to FIG. 1 FIG. 1 is a flowchart of a first embodiment according to the present invention. As shown FIG. 1, in step S11, the digital camera determines whether it is operating in an auto flash mode. The present invention solves problems associated with the digital camera operating in an auto flash mode. Therefore, if the digital camera operating in a mode other than the auto flash mode, such as a forced-flash mode or a no-flash mode, the method of the present invention finishes. That is, the digital camera cannot be used until the flash has charged.

Otherwise, if the digital camera is operating in an auto flash mode, in step S12 the camera determines whether the ambient light exceeds a predetermined value. In a preferred embodiment of the present invention, the predetermined value is a predetermined light value, and the predetermined light value is about 8.5, but may be other values.

If the ambient light is not higher than the predetermined value, then this indicates that the ambient light is not bright enough for a user to operate the digital camera. Therefore, the method of the present invention finishes, and again, the digital camera is not available for use until the flash has charged.

On the other hand, if the ambient light is higher than the predetermined value, then this indicates that the ambient light is sufficiently bright and the user does not need the flash to take a picture. In step S13, the digital camera is placed into a ready mode that permits the taking of pictures immediately.

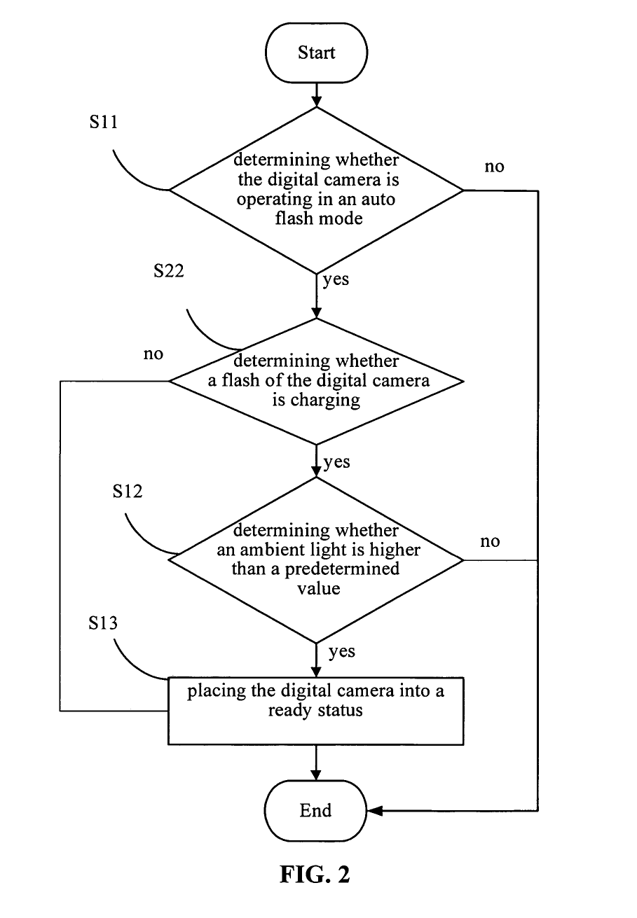

Please refer to FIG. 2. FIG. 2 is a flowchart of a second embodiment according to the present invention. As shown in FIG. 2, the present invention prevents the inconvenience that arises when the digital camera operates in an auto flash mode; that is, the digital camera cannot operate until the flash has fully charged. The second embodiment further comprises step S22, which includes determining whether the flash of the digital camera is still charging.

As shown in FIG. 2, after step S11, if the digital camera is not operating in an auto flash mode, the method of the present invention finishes, and the digital camera is not available for use until the flash has charged.

When the digital camera operates in an auto flash mode, step S22 is performed to determine whether the flash of the digital camera is still charging. Since the user only needs to wait when the flash is charging, when the result of step S22 is that the flash has fully charged, step S13 is performed to enable the digital camera to be used for capturing images immediately.

On the other hand, if the result of step S22 is that the flash is still charging, step S12 is performed to detect whether the ambient light is higher than the predetermined value. If the ambient light is higher than the predetermined value, step S13 is performed to enable of the camera for the immediate capturing of images. Since steps S12 and S13 are described in the first embodiment, they require no further description.

The method of the present invention increases the convenience of operating the digital camera when in an auto flash mode, and reduces the charging process of the flash to save power, permitting more pictures to be taken while extending battery times.

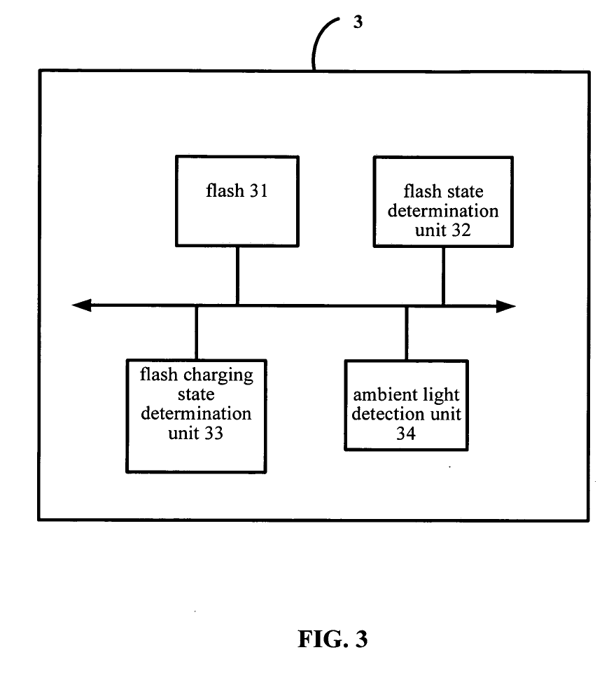

Moreover, the present invention also provides a digital camera that utilizes the method in the first embodiment or the second embodiment. Please refer to FIG. 3. FIG. 3 is a schematic drawing of a digital camera according to the present invention.

As shown in FIG. 3, the present invention also provides a digital camera 3, which can detect the ambient light to control the picture capturing process. The digital camera 3 comprises a flash 31, a flash state determination unit 32, a flash charging state determination unit 33 and an ambient light detection unit 34, which are all electrically connected together.

The flash 31 is used for providing light during the picture capturing process; the flash state determination unit 32 is used for executing step S11 to determine whether the digital camera is in the auto flash mode; the flash charging state determination unit 33 is used for executing step S22 to determine whether the flash is still charging; and the ambient light detection unit 34 is used for executing step S12 to detect whether the ambient light is higher than the predetermined value.

In the embodiments, the flash state determination unit 32, the flash charging state determination unit 33 and the ambient light detection unit 34 can be implemented not only in hardware but also in software, so long as they are capable of respectively performing steps S11, S22 and S12.

Although the present invention has been explained in relation to its preferred embodiment, it is to be understood that many other possible modifications and variations can be made without departing from the spirit and scope of the invention as hereinafter claimed.

What is claimed is:

1. A method for controlling a picture capturing process in a digital camera operating in an auto flash mode, the method comprising:
determining whether the digital camera is operating in the auto flash mode;
when the digital camera is operating in the auto flash mode, then further determining whether an ambient light is higher than a predetermined value; and
when the ambient light is higher than the predetermined value, placing the digital camera into a ready status that is capable of capturing pictures immediately.

2. The method as claimed in claim 1, wherein when the digital camera is not in the auto flash mode, the method for controlling the picture capturing process of the digital camera completes.

3. The method as claimed in claim 1, wherein when the ambient light is not higher than the predetermined value, the digital camera is inoperable until a flash of the digital camera has charged.

4. The method as claimed in claim 1, wherein the predetermined value is a predetermined light value.

5. The method as claimed in claim 4, wherein the predetermined light value is about 8.5.

6. A method for controlling a picture capturing process of a digital camera, the method comprising:
determining whether the digital camera is operating in an auto flash mode;
when the digital camera is operating in the auto flash mode, then further determining whether a flash of the digital camera is charging;
when the flash of the digital camera is charging, then further detecting whether an ambient light value is higher than a predetermined value; and
when the ambient light value is higher than the predetermined value, then causing the digital camera to enter into a ready status that is capable of capturing pictures immediately.

7. The method as claimed in claim 6, wherein when the digital camera is not in the auto flash mode, the method for controlling the picture capturing process of the digital camera completes.

8. The method as claimed in claim 6, wherein when the flash of the digital camera is not charging, the digital camera is available for operation.

9. The method as claimed in claim 6, wherein when the ambient light is not higher than the predetermined value, the digital camera is inoperable until the flash has charged.

10. The method as claimed in claim 6, wherein the predetermined value is a predetermined light value.

11. The method as claimed in claim 10, wherein the predetermined light value is about 8.5.

12. A digital camera capable of controlling an operation by detecting an ambient light, the digital camera comprising:
a flash for providing illumination during a picture capturing process;
a flash state determination unit for determining whether the flash is operating in an auto flash mode to operate the digital camera; and
an ambient light detection unit for detecting whether the ambient light is higher than a predetermined value when the digital camera is operating in the auto flash mode; wherein when the ambient light is higher than the predetermined value, the ambient light detection unit places the digital camera into a ready status that is capable of capturing pictures immediately, and when the ambient light is not higher than the predetermined value, the digital camera is inoperable until the flash has charged.

13. The digital camera as claimed in claim 12 further comprising a flash charging state determination unit for determining whether the flash is charging when the digital camera is operating in the auto flash mode; wherein when the flash is still charging, the flash charging state determination unit causes the ambient light detection unit to detect the ambient light.

14. The digital camera as claimed in claim 12, wherein the predetermined value is a predetermined light value.

15. The digital camera as claimed in claim 14, wherein the predetermined light value is about 8.5.
